(19) United States
(12) Patent Application Publication
(10) Pub. No.: US 2014/0207614 A1
(43) Pub. Date: Jul. 24, 2014

(54) METHOD AND SYSTEM FOR ASSISTING CUSTOMERS IN RETAIL STORES

(71) Applicant: TATA CONSULTANCY SERVICES LIMITED, Mumbai (IN)

(72) Inventors: Satyanarayanan Ramaswamy, Cupertino, CA (US); Ajaykumar Idnani, Hoffman Estates, IL (US); Gitanjali Gulve Sehgal, Cupertino, CA (US)

(73) Assignee: Tata Consultancy Services Limited, Mumbai (IN)

(21) Appl. No.: 13/849,789

(22) Filed: Mar. 25, 2013

(30) Foreign Application Priority Data
Jan. 18, 2013 (IN) 178/MUM/2013

(51) Int. Cl. G06Q 30/06

(52) U.S. Cl. CPC G06Q 30/0613
USPC 705/26.41

(57) ABSTRACT

Methods and systems for assisting customers in retail stores are described. The method comprises obtaining one or more assistance requests from a customer mobile device. The one or more assistance requests include customer device location and assistance information. Further, the assistance information includes at least one of a customer image, a text message, a video, and an audio. The method further comprises analyzing the one or more assistance requests to obtain assistance details. The assistance details include customer data and store associate data. Further, the method comprises transmitting the customer data and the store associate data to store associate mobile devices and the customer mobile device respectively for assisting the customer.

### CLAIM OF PRIORITY

This application claims the benefit of priority of Indian Patent Application Serial Number 178/MUM/2013, entitled “METHOD AND SYSTEM FOR ASSISTING CUSTOMERS IN RETAIL STORES,” filed on Jan. 18, 2013, the benefit of priority of which is claimed hereby, and which is incorporated by reference herein in its entirety.

### TECHNICAL FIELD

The present subject matter relates, in general, to providing assistance to customers, in particular, to a system and a method for assisting customers in retails stores.

### BACKGROUND

Retail stores have their presence around the world and are growing day by day to meet needs of customers. Nowadays, the retail stores offer a wide range of products of different brands under one roof, i.e., at one location. In such retails stores, different quality of products, in different quantities with different rates that suit the needs of the customers are made available. Therefore, such multi-brand retails stores allow the customers to buy various types of products from one place, which helps in saving time and other resources of the customers. A customer can easily compare products of different brands and buy the product which suits him best.

Typically, the multi-brand retail stores, such as Wal-Mart™, Carrefour™, Tesco™, Metro AG™, and Kruger™ are huge in size varying from 98,000 to 261,000 square feet. The whole retail store is generally divided into multiple aisles located on depending upon the category of product. For example, apparels may be kept in one aisle and electronic items may be kept in another aisle. Further, some retail stores are set up on multiple floors. Therefore, it may become difficult for a customer to locate a store associate or store representative whenever any kind of assistance is needed. The customer may need to go through multiple aisles just to find out the store associate, and it is very much possible that he may not find the store associate having knowledge of the product, for which the customer is seeking assistance. The store associate having knowledge of the product for which assistance is needed may be referred to a right store associate. In cases where the right associate is not found, the store associate may not be able to provide assistance to the customer and may help the customer in locating the right store associate. But in such cases, the customer has to wait till the right store associate comes for the assistance. To overcome such situations, kiosks are set up in the retail stores. Whenever any kind of assistance is needed, the customers may go to one of the kiosks.

### SUMMARY

This summary is provided to introduce concepts related to assisting customers in retail stores. These concepts are further described below in the detailed description. This summary is not intended to identify essential features of the claimed subject matter nor is it intended for use in determining or limiting the scope of the claimed subject matter.

In one embodiment, method and system for assisting a customer in retail stores are described. The method comprising obtaining one or more assistance requests from a customer mobile device. The one or more assistance requests include customer location and assistance information. Further, the assistance information includes at least one of a customer image, a text message, a video, and an audio. The method further comprising analyzing the one or more assistance requests to obtain assistance details. The assistance details include customer data and store associate data. Further, the method comprises transmitting the customer data and the store associate data to store associate mobile devices and the customer mobile device respectively for assisting the customer.

### BRIEF DESCRIPTION OF THE DRAWINGS

The detailed description is described with reference to the accompanying figure(s). In the figure(s), the left-most digit(s) of a reference number identifies the figure in which the reference number first appears. The same numbers are used throughout the figure(s) to reference like features and components. Some embodiments of systems and/or methods in accordance with embodiments of the present subject matter are now described, by way of example only, and with reference to the accompanying figure(s), in which:

FIG. 1(a) illustrates a network environment implementing a customer assistance system, according to an embodiment of the present subject matter.

FIG. 1(b) illustrates a network environment implementing the customer assistance system, according to another embodiment of the present subject matter.

FIG. 2 illustrates a method for assisting customers in retail stores, according to an embodiment of the present subject matter.

### DETAILED DESCRIPTION

Whenever a customer visits a retail store, the customer may face lot of issues, such as not able to locate product, insufficient product details, not happy with available products, and needs some suggestions. To solve such issues faced by the customers, the retail stores have employed store associates who have knowledge about their respective department. For example, a store associate may be expert in electronic items but not in apparels. Whenever the customer faces any issue, the customer may want to talk with one of the store associates of the respective department.

Conventionally, various approaches are used for providing assistance to customers in retails stores. In one conventional approach, help buttons may be provided in the retail stores. The customers may press one of the help buttons located near to him, whenever any kind of assistance is required from a store associate. For example, if a customer needs some assistance, then the customer presses the help button and waits for the store associate to come. In such cases, the customer may have to wait for a long time till the store associate shows up and at the same time, the customer does not have any idea about how long he/she needs to wait for the store associate to get any kind of assistance. Further, the customers may decide to wander around while waiting for the store associate. In such situations, if the store associate were to show up during such time, it would be difficult for the store associate to locate and identify the customer who has sought assistance, resulting in loss of time and opportunity for assisting the customers. At the same time, the customer will miss the opportunity to receive assistance that the customer was trying to seek in the first place. In addition, if there are more than one customers are waiting for the store associate in the same aisle for assistance, then it may become difficult for the store associate to decide whom to assist first.

In accordance with the present subject matter, a method and a system for assisting customers in retail stores are described. The present subject matter allows the customer to register an assistance request and the store associate to locate the customer who has registered the assistance request. Accordingly, the present subject matter facilitates the customer to be conveniently serviced, and on the other hand, facilitates the store associates to effectively provide the service to the customers. With the present subject matter, the store associate may have all the details needed to provide assistance to the customer in the retail store. The store associate is in possession of location and picture of the customer looking for the assistance. Also, the customer has an idea about waiting time and information about the store associate who is going to provide assistance.

In one embodiment of the present subject matter, whenever any kind of assistance is needed by a customer from a store associate, the customer may register for one or more assistance requests through a customer mobile device. The customer mobile device may be defined as a device capable of identifying the position or location of the customer, and capturing customer information, say picture of the customer. In one example, the customer mobile device may be provided by the retail stores. In another example, customers may use their own mobile device as the customer mobile device. The customer mobile device may include handheld devices and personally wearable devices, such as cell phone, tablet, and smart watches.

While registering for the one or more assistance request, the customer may provide assistance information in the one or more assistance request. In one implementation, the customer may capture his/her picture using a camera of the customer mobile device. Hereinafter the picture of the customer may be referred to as a customer picture. In one implementation, the customer image may be obtained from gallery of the customer mobile device. Further, in another implementation, the customer may provide a text message in the one or more assistance requests. For example, the customer may provide the text message stating “where is product A?” In yet another implementation, the customer may provide an audio and a video in the assistance request for communicating some message to the store associate. Therefore, the assistance information may include the customer picture, the audio, the video, and the text message.

In one implementation, the assistance request may also include customer location. The customer location may be determined by the customer mobile device or, in other cases, by a remote device monitoring the customer mobile device, and provide the location to the customer mobile device. In the latter case, the customer device may then include the location in the assistance request. The customer location may help the store associate to locate the customer who is seeking for the assistance. In an implementation, the customer location may be updated periodically to a current customer location so that the store associate gets to know the current location of the customer. For example, if the customer made the assistance request in “aisle A”, but the customer wanders and move to “aisle B”, then the location of the customer will be updated and the store associate would easily locate the customer in the current customer location, which “aisle B” in the said example.

In one implementation, a customer assistance system (hereinafter referred to as a system), say a back-office server, may receive the one or more assistance request from one or more customer mobile devices in the retail store for analysis. The system analyzes the one or more assistance requests from the customers to obtain customer data and store associate data. The customer data may include information which is to be transmitted to store associate mobile devices and the store associate data may include information to be transmitted to the customer mobile device. In one implementation, the system may check whether the assistance needed by the customer require personal assistance by the store associate or not by analyzing the text message provided in the one or more assistance requests. In case, if the text message provided by the customer is not complex, then the system may provide the assistance to the customer by sending an assistance response to the customer mobile device and the store associate may not be needed in such cases. However, if the text message is complex, the system may assign a store associate to the customer for providing assistance.

In one implementation, the system may determine which store associate to assign to provide assistance to the customer based on at least one selection parameter. The at least one selection parameter may include, availability of the store associate, specialty of the store associate, queue length of assistance request for the store associate, and proximity of the store associate to the customer in need of the assistance. In an example, there are two store associates having knowledge about electronic items and one of the store associate is in “aisle A” and the other store associate is in “aisle B”. In such cases, if an assistance request is made from “aisle A”, then the store associate in the “aisle A” may be assigned to the customer seeking for the assistance. In another example, if the store associates proximate to the customer from whom the assistance request is received are busy with some other customer, then another store associate who is available at that time may be assigned to assist the customer.

In one implementation, the system may analyze the one or more assistance requests to decide an order in which the store associate may serve the customers. The order may be serviced according to one or more modes, such as first come first serve, volume of purchase, whether a customer is a privileged customer or not, potential to purchase, and reward points given to the customers. For example, if one customer has bought products having more worth than the products bought by another customer, then the customer having product with higher worth may be provided with assistance first.

Further, in one implementation, the system may determine an expected time-to-arrive based on availability of the store associates. The expected time-to arrive may be defined as time required by the store associate to reach the customer who has made the assistance request. Further, the system provides the customer data to the various store associate mobile devices, servicing the customers in that store. The customer data may include the customer location, the customer picture, the text message, the video, the audio, and the order in which the store associate will assist the customers. Therefore, after receiving the customer data, the store associate assigned to the customer may have the assistance information, say the customer picture, the text message, and the customer location, the latter getting updated to the current customer location periodically on the store associate mobile device. With the help of all this information on the store associate mobile device, the store associate may easily locate the customer and provide assistance to the customer.

Further, in said implementation, the store associate data may be transmitted to the customer mobile device. The store associate data may include an expected time-to-arrive of a store associate, the assistance response, and details of the store associate assigned to assist the customer. This may allow the customer to identify the store associate who is going to provide assistance and the customer will have an idea that for how long they have to wait for the assistance.

In another embodiment of the present subject matter, the customer device may directly communicate with the store associate mobile device, without the intervention of the back office server. In such cases, the store associate mobile devices may be configured to receive the one or more assistance requests and broadcast or multicast an acceptance message to the other store associate mobile devices and the customer mobile devices. In said embodiment, the customer mobile device may broadcast or multicast the assistance request in a local network to which the store associate mobile devices are also connected. The store associate mobile devices may be configured to obtain the broadcast assistance request from the customer mobile device. Further, the store associate mobile device may inform the store associate that the assistance request is received from one of the customers. In such cases, there is a possibility that more than one store associates may decide to provide the assistance to the customer. To avoid such conflict, a conflict resolution mechanism may be employed by the system. In one example, to avoid the conflict, in response to the assistance requests, one store associate mobile device may broadcast or multicast the acceptance message to the other store associate mobile devices and the customer mobile device in the local area network. The acceptance message informs other store associates that the assistance request is being handled by the store associate sending out the acceptance message. At the same time, acceptance message may provide details to customer about the expected time-to-arrive and details of the store associate who has opted for providing assistance.

Therefore, the present subject matter allows the store associate to provide assistance to the customers in a systematic manner. With the present subject matter, the customer may get assistance very quickly and that too from the store associate having expertise in categories of products located in an aisle from where the customer has requested for assistance. In addition, the customer has an idea that for how long they have to wait for getting assistance. Further, after making the one or more assistance requests, the customer may check out other products placed in different aisles because the customer location is getting updated periodically. The store associate may easily identify the customer who has made the one or more request with the help of the customer picture received on the store associate mobile device. This may help in increasing the overall experience of the customers in the retail stores and at the same time allow the store associates to handle the assistance requests from the customers efficiently. Therefore, the systems and the methods in accordance with the present subject matter provide assistance to customers in retail stores, and allow the store associate to provide assistance to the customers by reaching to the customer with the help of the customer picture and the customer location obtained.

The following disclosure describes the system and the method for assisting customers in retail stores. While aspects of the described system and method can be implemented in any number of different computing systems, environments, and/or configurations, embodiments for providing assistance to customers are described in the context message of the following exemplary system(s) and method(s).

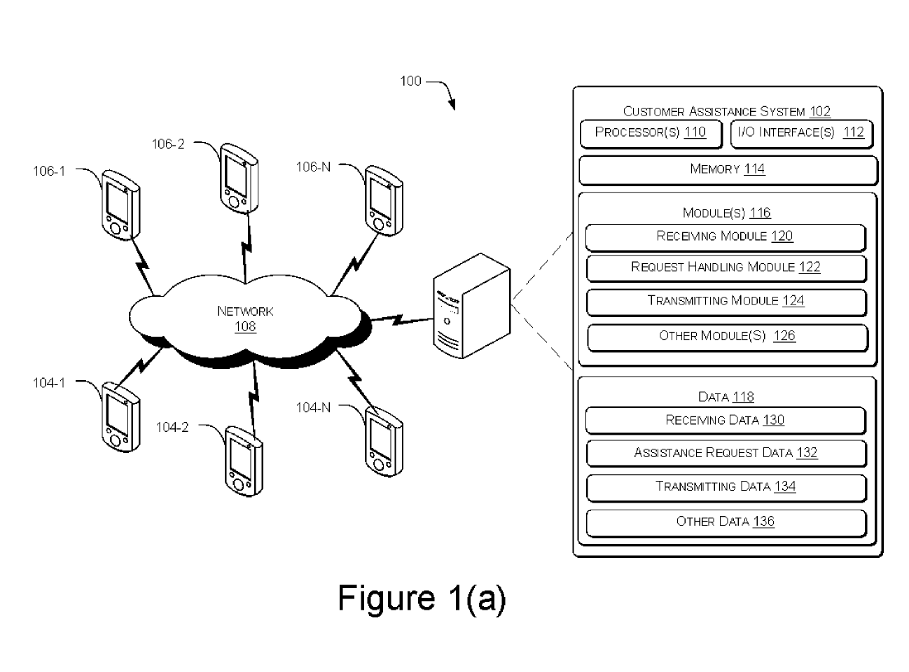

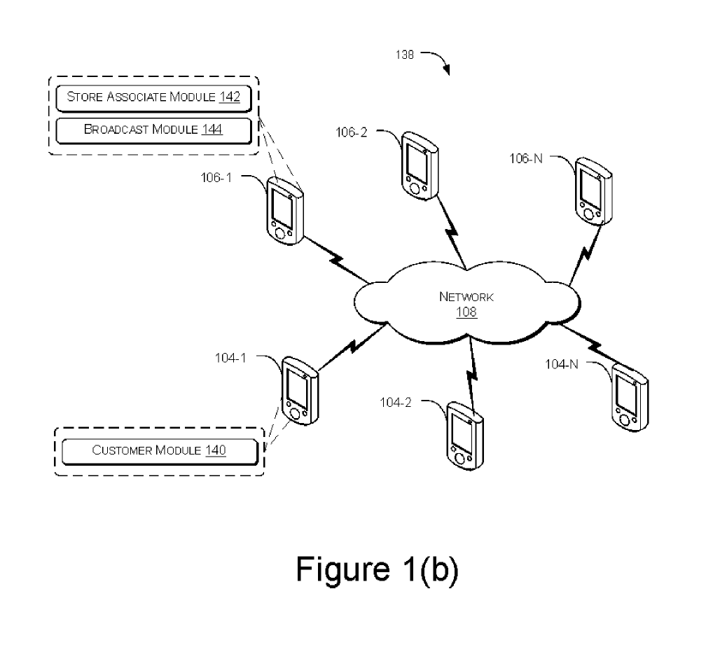

FIG. 1(a) illustrates a network environment 100 implementing a customer assistance system 102, in accordance with an embodiment of the present subject matter.

In one implementation, the network environment 100 can be a public network environment, including thousands of personal computers, laptops, various servers, such as blade servers, and other computing devices. In another implementation, the network environment 100 can be a private network environment with a limited number of computing devices, such as personal computers, servers, laptops, and/or communication devices, such as mobile phones and smart phones.

The customer assistance system 102 (hereinafter referred to as a system 102) is communicatively connected to a plurality of customer mobile devices 104-1, 104-2, 104-3 . . . , and 104-N, collectively referred to as customer mobile devices 104 and individually referred to as a customer mobile device 104, through a network 108. Further, the system 102 is also communicatively coupled to a plurality of store associate mobile devices 106-1, 106-2, 106-3 . . . , and 106-N, collectively referred to as store associate mobile devices 106 and individually referred to as a store associate mobile device 106, through the network 108. In one implementation, a plurality of customers in retail stores may use the customer mobile devices 104 to communicate with the system 102. In one embodiment, the system 102 may be implemented in the store associate mobile devices 106.

The system 102, the customer mobile devices 104, and the store associate mobile devices 106 may be implemented in a variety of computing devices, including, servers, a desktop personal computer, a notebook or portable computer, a workstation, a mainframe computer, a laptop and/or communication device, such as mobile phones and smart phones. Further, in one implementation, the system 102 may be a distributed or centralized network system in which different computing devices may host one or more of the hardware or software components of the system 102.

The system 102 may be connected to the customer mobile devices 104 and the store associate mobile devices 106 over the network 108 through one or more communication links. The communication links may be enabled through a desired form of communication, for example, via dial-up modem connections, cable links, digital subscriber lines (DSL), wireless, or satellite links, or any other suitable form of communication.

The network 108 may be a wireless network, a wired network, or a combination thereof. The network 108 can also be an individual network or a collection of many such individual networks, interconnected with each other and functioning as a single large network, e.g., the Internet or an intranet. The network 108 can be implemented as one of the different types of networks, such as intranet, local area network (LAN), wide area network (WAN), the internet, and such. The network 108 may either be a dedicated network or a shared network, which represents an association of the different types of networks that use a variety of protocols, for example, Hypertext message Transfer Protocol (HTTP), Transmission Control Protocol/Internet Protocol (TCP/IP), etc., to communicate with each other. Further, the network 108 may include network devices, such as network switches, hubs, routers, for providing the one or more communication links. The network devices within the network 108 may interact with the system 102, the customer mobile devices 104, and the store associate mobile devices 106 through the communication links.

According to an embodiment of the present subject matter, the system 102 may be configured as a back-office server of retail stores for providing assistance to customers. Typically, whenever customers visit any retail stores, the customer may need some assistance regarding products available in the retails stores. For assisting the customers, the retail stores may have employed store associates. Each of the store associate may be trained for handling queries of the customers related to some specific section in the retail store. For example, a store associate may have knowledge about grocery items and another store associate may have knowledge about home decor. Further, whenever assistance is needed by the customers, it may become difficult for them to find one store associate to help them and it may be possible that the customer may not find the store associate having knowledge about the product for which the customer is seeking assistance. The system 102 may allow the store associate to assist the customers and may inform the customer that for how long he/she needs to wait for the assistance.

For the purpose, the system 102 may include one or more processor(s) 110, I/O interface(s) 112, and a memory 114 coupled to the processor 110. The processor 110 can be a single processing unit or a number of units, all of which could include multiple computing units. The processor 110 may be implemented as one or more microprocessors, microcomputers, microcontrollers, digital signal processors, central processing units, state machines, logic circuitries, and/or any devices that manipulate signals based on operational instructions. Among other capabilities, the processor 110 is configured to fetch and execute computer-readable instructions and data stored in the memory 114.

The I/O interface(s) 112 may include a variety of software and hardware interfaces, for example, but not limited to interfaces for peripheral device(s), such as a keyboard, a mouse, a display unit, an external memory, and a printer. Further, the I/O interface(s) 112 may enable the system 102 to communicate with other devices, such as the customer mobile device 104, the store associate mobile device 106, web servers and external databases. The I/O interface(s) 112 can facilitate multiple communications within a wide variety of networks and protocol types, including wired networks, for example, local area network (LAN), cable, etc., and wireless networks, such as Wireless LAN (WLAN), cellular, or satellite. For the purpose, the I/O interface(s) 112 include one or more ports for connecting a number of computing systems with one another or to a network.

The memory 114 may include any non-transitory computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The non-transitory computer-readable medium, however, excludes a transitory, propagating signal. In one implementation, the system 102 also includes module(s) 116 and data 118.

The module(s) 116, amongst other things, include routines, programs, objects, components, data structures, etc., which perform particular tasks or implement data types. The module(s) 116 may also be implemented as, signal processor(s), state machine(s), logic circuitries, and/or any other device or component that manipulate signals based on operational instructions.

Further, the module(s) 116 can be implemented in hardware, instructions executed by a processing unit, or by a combination thereof. The processing unit can comprise a computer, a processor, such as the processor 110, a state machine, a logic array or any other suitable devices capable of processing instructions. The processing unit can be a general-purpose processor which executes instructions to cause the general-purpose processor to perform the required tasks or, the processing unit can be dedicated to perform the required functions.

In another aspect of the present subject matter, the module(s) 116 may be machine-readable instructions (software) which, when executed by a processor/processing unit, perform any of the described functionalities. The machine-readable instructions may be stored on an electronic memory device, hard disk, optical disk or other machine-readable storage medium or non-transitory medium. In one implementation, the machine-readable instructions can be also be downloaded to the storage medium via a network connection.

In one implementation, the module(s) 116 further include a receiving module 120, a request handling module 122, a transmitting module 124, and other module(s) 126. The other modules 126 may include programs or coded instructions that supplement applications and functions of the system 102.

The data 118 serves, amongst other things, as a repository for storing data processed, received, and generated by one or more of the modules 116. The data 118 includes receiving data 130, assistance request data 132, transmitting data 134, and other data 136. The other data 136 includes data generated as a result of the execution of one or more modules in the modules 116.

It will be understood that although the description of the present subject matter is provided with reference to the customer mobile device 104 and the store associate mobile device 106, the present subject matter is applicable for communication between any two mobile devices 104 and 106, referred to as a first mobile device 104 and a second mobile device 106, communicating with each other.

In one implementation, the receiving module 120 may be configured to register one or more assistance requests from the customers with the help of the customer mobile devices 104, whenever any kind of assistance is needed in the retails stores. The one or more assistance may include customer location and assistance information. The assistance information may be defined as information provided by the customer in the one or more assistance request by using the customer mobile device 104, such as a customer picture, a text message, an audio, and a video. The receiving module 120 may be configured to receive the customer picture, captured by the customer using a camera provided in the user mobile device 104. The customer may use either a primary camera or a secondary camera for capturing the customer picture. In another implementation, the receiving module 120 may be configured to select the customer picture which is pre-stored in the customer mobile device 104. In another implementation, the receiving module 120 may create a profile for each of the customers when the one or more assistance requests are made by the customers. The profile created may be then used by the receiving module 120, when the customer registers the one or more request for the second time. This may help in saving additional processing time needed for transmitting the customer picture again and again when time the same customer registers for the one or more assistance requests. Further, the receiving module 120 may provide an option to the customer to change the customer picture stored under profile of the customer.

In one implementation, the receiving module 120 may be configured to receive a text message input by the customer using the customer mobile device 104. Further, the receiving module 120 may include the text message in the one or more assistance requests. In one example, the receiving module 120 may be configured to receive the text message having a question, i.e., “In which aisle the product A is located?” The customer may provide the text message in the one or more assistance requests by using the customer mobile device 104. In another example, the text message may include information about product for which the assistance is required.

In one implementation, the receiving module 120 may be configured to receive an audio or a video captured by the customer using the customer mobile device 104. The receiving module 120 may include the audio and the video in the one or more assistance request for communicating some message to the store associate. The customer may record the audio and video by using a microphone and the camera provided in the customer mobile device 104.

Further, based on the customer preferences, the one or more assistance request include at the customer picture, the text message, the audio, and the video in the one or more assistance requests. For example, the customer may want to send only the customer picture in the on or more assistance requests. In another example, the customer may want to send the video along with the text message.

Thereafter, the receiving module 120 may be configured to receive customer location in the one or more assistance requests. In one implementation, the customer location may be determined with the help of the customer mobile device 104, when the customer is registering for the one or more assistance requests. The customer location may be determined by using conventional know techniques for determining indoor locations, such as Wi-Fi triangulation, cellular and Wi-Fi coverage fingerprints, and, audio beacons. This may help the store associate to locate the customer who is seeking for the assistance. Therefore, the one or more assistance requests may comprise the customer location and at least of the customer picture, the text message, the audio, and the video.

In one implementation, the customer location may be updated periodically to a current customer location. The receiving module 120 may be configured to receive the current customer location periodically so that the store associate is always informed about the current location of the customer. For example, if the customer made the assistance request in when he was in “aisle A”, but the customer wanders and move to “aisle B”, then the location of the customer will be updated to “aisle B” and the store associate would easily locate the customer in the current customer location. Thereafter, the receiving module 120 may store the one or more assistance requests in the receiving data 130 and may update the customer location to the current customer location periodically. In one implementation, the receiving module 120 may store the current customer location in the receiving data 130 upon determining that the current customer location is different than the customer location. For example, the customer location may be updated in every 2 minutes and if the customer has changed his/her location, then only the current customer location is updated in the receiving data 130. Furthermore, the store associate may be reassigned to the customer, if the current customer location is far from the customer location by a predefined distance. For example, if the customer moves in the retail store and reaches to the current customer location which is one kilometer far from the customer location, then the store associate may be re-assigned to the customer based on the current customer location.

In one implementation, the request handling module 122 may be configured to obtain the one or more assistance requests for analyzing from the receiving data 130. The request handling module 122 analyzes the one or more assistance requests to obtain customer data and store associate data. The customer data and the store associate data may include data which is to be transmitted to the store associate mobile device 106 and the customer mobile device 104 respectively.

In one implementation, the request handling module 122 may identify whether the assistance needed by the customer requires personal assistance from the store associate or not based on the text message provided in the one or more assistance requests. In case, the request handling module 122 identifies that the assistance needed by the may not require personal assistance from the store associate based on analyzing the text message, then the assistance request module 122 may provide the assistance to the customer by sending assistance response to the customer mobile device 104. For example, if the has asked for the location of product A, price of product A, and expiry of product A, the request handling module 122 may obtain the answers of such questions from a repository (not shown in figure) having all the information about the products. The answer may be then transmitted to the customer mobile device 104 in the form the assistance response and the assistance from the store associates may not be needed in such cases. However, if the request handling module 122 identifies that query asked in the text message of the one or more assistance that personal assistance is needed, then the request handling module 122 may assign a store associate to the customer for providing assistance. For example, if the request handling module 122 identifies that in the text message, the customer has asked for comparison between two products, then the request handling module 122 may assign the store associate to the customer for proving assistance.

In one implementation, the request handling module 122 may be configured to cancel the one or more assistance requests. For example, the customer who has registered the one or more assistance requests may cancel the one or assistance request, in case, the assistance is no longer needed by the customer.

In one implementation, the request handling module 122 may determine which store associate to assign to provide assistance to the customer based on at least one selection parameter. The at least one selection parameter may include, availability of the store associate, specialty of the store associate, queue length of assistance request for the store associate, and proximity of the store associate to the customer in need of the assistance. For example, if the request handling module 122 determines that there are two store associates who have knowledge about electronic items and one of the store associate is in “aisle A” and the other store associate is in “aisle B”. In such cases, if the request handling module 122 determines that the one or more assistance requests are made from “aisle A”, then the request handling module 122 may assign the store associate in the “aisle A” to the customer seeking for the assistance. In another example, if the request handling module 122 identifies that the store associate proximate to the customer is busy with some other customer, then the request handling module 122 may assign another store associate who is available at that time.

In one implementation, the request handling module 122 may analyze the one or more assistance requests to decide an order in which the store associate may serve the customers. The request handling module 122 may decide the order of providing the assistance to the customers according to one or more modes, such as first come first serve, volume of purchase, whether a customer is a privileged customer or not, potential to purchase, and reward points given to the customers. For example, if one customer has bought products having more worth than the products bought by another customer, then the customer having product with higher worth may be given higher priority in the order of serving the customers. In another example, if the customer is a premium customer who has 100 reward points, then the customer may be given higher priority than the normal customers in the order of providing the assistance.

Further, in one implementation, the request handling module 122 may determine an expected time-to-arrive based on availability of the store associates. The expected time-to arrive may be defined as time required by the store associate to reach the customer who has made the assistance request. For example, the request handling module 122 may determine that all the store associates having knowledge of the products about which the customer is seeking assistance are busy or located at some distance from the customer. In such cases, the request handling module 122 may determine the expected time-to-arrive based on the availability of the store associates and the distance of the store associates from the customer seeking assistance.

Subsequently, the request handling module 122 may obtain the customer data and the store associate data. The customer data and the store associate data may include data which is to be transmitted to the store associate mobile device 106 and the customer mobile device 104 respectively. In one implementation, the customer data may include the customer location, the customer picture, the text message, the audio, the video, and the order in which the store associate may assist the customers. In one implementation, the store associate data may include the expected time-to-arrive of a store associate, the assistance response, and details of the store associate assigned to assist the customer. This may allow the customer to identify the store associate who is going to provide assistance and the customer will have an idea that for how long they have to wait for the assistance. In one implementation, the request handling module 122 may store the customer data and the store associate data in the assistance request data 132.

Once the customer data and the store associate are obtained, the transmitting module 124 may transmit the customer data and the store associate data to the store associate mobile device 106 and the customer mobile device 104 respectively. In one implementation, the transmitting module 124 may store the customer data and the store associate data in the transmitting data 134 before transmitting to the store associate mobile devices 106 and the customer mobile devices 104 respectively. The customer data on the store associate mobile device 106 may allow the store associate to easily locate the customer in the retail store with the help of the current customer location and the customer picture. Further, the store associate data on the customer mobile device 104 provide information about the assistance to the customer, such as the expected time-to-arrive, the assistance response, and the details about the store associate assigned to the customer for providing assistance. The detail of the store associate may include name and picture of the store associate. Therefore, the customer is in possession of all the details, which may improve the overall experience of the customer in the retail store.

With the help of present subject, the customer is under no dilemma that who is going to assist him/her and for how long he/she has to wait for the assistance. Further, the customer may roam freely in the retail store without worrying about whether the store associate would be able to locate him/her or not. The present subject matter also helps the store associates in the retail stores to handle the customer request efficiently. Now, the right store associate may provide the assistance to the customer without any delay in service.

FIG. 1(b) illustrates a network environment 138 implementing the customer assistance system 102 configured in the customer mobile devices 104 and the store associate mobile devices 106, according to an embodiment of the present subject matter.

In said embodiment of the present subject matter, the customer mobile devices 104 and the store associate mobile devices 106 are directly communicatively coupled to each other over the network 108. In an example, the functionalities of handling the assistance requests residing with the system 102 in the previous embodiment are provided to the store associate mobile device 106. In one implementation, the customer mobile device 104 may comprises a customer module 140 and the store associate mobile device 106 may comprises a store associate module 142 and a broadcast module 144.

In one implementation, the customer module 140 may be configured in the customer mobile devices 104. The store associate module 142 and the broadcast module 140 may be configured in the store associate mobile devices 106. Although, the customer module 140 has been shown in only one of the customer mobile device 104 in FIG. 1(b), it may be understood that the customer module is 140 is configured in the other customer mobile devices 104 also. Similarly, the store associate module 142 and the broadcast module 144 may be configured in each of the store associate mobile devices 106.

In one implementation, the customer module 140 configured in the customer mobile device 104 may allow the customer to broadcast the one or more assistance requests in the network 108, whenever any kind of assistance is needed by the customer in the retail store. It will be understood by a person having ordinary skill in the art that the broadcast may include multicast. As mentioned earlier, the one or more request may include the customer location and the assistance information. The assistance information may include information provided by the customer, such as the customer picture, the text message, the audio, and the video. In one implementation, the customer module 140 may allow the customer to capture the customer picture, input the text message, determining the customer location, and capturing the audio and the video.

Further, the store associate module 142 configured in the store associate mobile device 106 may receive the one or more request from the network 108. Once the one or more requests are received by the store associate module 142, with the help of the store associate mobile devices 106, the store associate may opt for providing the assistance to the customer based on their availability and expertise. In some cases, it may be possible that more than one store associates opt for providing the assistance to the same customer seeking for the assistance. To avoid such conflict situations, the broadcast module 142 may be configured to broadcast or multicast an acceptance message to the other store associate mobile devices 106 and the customer mobile devices 104. The acceptance message informs other store associates that the assistance request is being handled by another store associate. Further, customer module 140 may also capture the acceptance message to get details to customer about the expected time-to-arrive and details of the store associate who has opted for providing assistance.

In an embodiment, the present subject matter may also be used in various scenarios. In one scenario, the system 102 may be used in situation where a first person is looking to meet a second person, and where the first person and the second person are unknown to each other. For example, the first person is visiting a new city and the second person is supposed to pick the first person from the airport-both the first person and the second person are new to each other. For the sake of explaining the present embodiment with respect to previously mentioned embodiment, the customer and the store associate may be referred to as the first person and the second person respectively. Similarly, the customer mobile device 104 and the store associate mobile device 106 may be referred to as a first mobile device 104 and a second mobile device 106 respectively.

In such situations, the first mobile device 104 may be configured to allow the first person to transmit his picture and present location to the second mobile device 106. The second mobile device 106 may capture the picture and the location of the first person. Further, the second mobile device 106 may allow the second person to transmit his picture and location to the first person. That is how both the first person and the second person will be in possession of the picture and the location of each other. Therefore, the first person and the second person can meet without requiring the second person to hold a placard with name of the first person. Further, this may also help in precluding the case where the first person could get picked up by a wrong person, or conversely the second person picks up a wrong person.

In another scenario, the present subject matter may be helpful in situation where broadcast or multicast of a picture of missing or suspicious person is required. For example, whenever a suspicious person is identified in the retail store, the picture of the suspicious person may be captured and then may be circulated to the store associate mobile device 106 in the retail store. The store associates may then identify and locate the suspicious person in the store based on the picture of the suspicious person. In another example, a picture of the missing person in the areas, such as retail stores, may be forwarded to the store associate mobile device 106. In yet another scenario, the present subject matter may help police to identify the person seeking help. For example, the person in danger may forward his/her picture and location to a mobile device of the police so that the police can easily locate and identify the person seeking help. This may also help in avoiding situation where the police may get confused while identifying a criminal and the person seeking assistance.

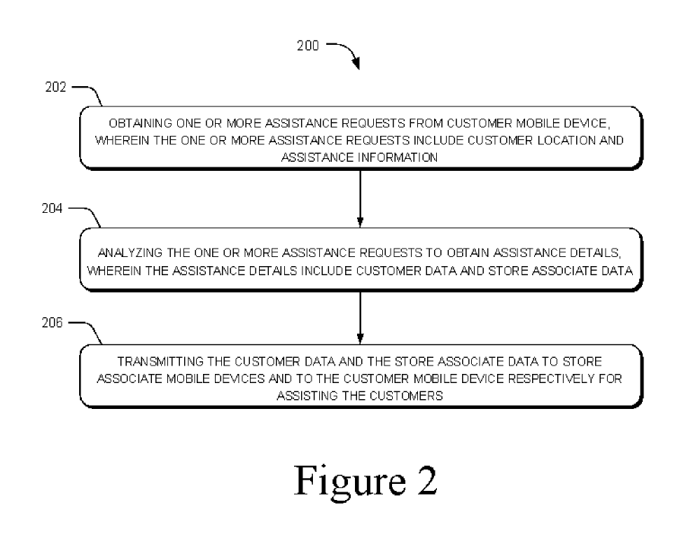

FIG. 2 illustrates a method 200 for assisting customers in retail stores, in accordance with an embodiment of the present subject matter. The method 200 may be described in the general context message of computer executable instructions. Generally, the computer executable instructions can include routines, programs, objects, components, data structures, procedures, modules, functions, etc., that perform particular functions or implement particular abstract data types. The method 200 may also be practiced in a distributed computing environment where functions are performed by remote processing devices that are linked through a communications network. In a distributed computing environment, computer executable instructions may be located in both local and remote computer storage media, including memory storage devices.

The order in which the method 200 is described is not intended to be construed as a limitation, and any number of the described method blocks can be combined in any order to implement the method, or an alternative method. Additionally, individual blocks may be deleted from the method without departing from the spirit and scope of the subject matter described herein. Furthermore, the method can be implemented in any suitable hardware, software, firmware, or combination thereof.

At block 202, one or more assistance requests are obtained from customer mobile devices 104. The one or more requests may include customer location and assistance information. The assistance information may be defined as information provided by the customer seeking assistance through the mobile device, such as a customer image, a text message, an audio and a video. In one implementation, the system 102 may receive the customer to capture his/her picture, and the video with the help of a camera in the customer mobile device 104, input the text, and record the audio through the a microphone in the customer mobile device 104. Further, the system 102 may determine the customer location using conventionally known location finder technologies, such as Wi-Fi triangulation, cellular and Wi-Fi coverage fingerprints, and audio beacon. Thereafter, the one or more assistance requests may be transmitted by the receiving module 120.

At block 204, the one or more assistance requests are analyzed to obtain assistance details. The assistance details include customer data and store associate data. The customer data may include the customer location, the customer picture, the text message, the audio, the video, and an order in which the store associate may assist the customers. In one implementation, the order of serving the customer may be obtained by analyzing the one or more assistance requests. For example, the customer who has asked for the assistance first may be served first. Further, the store associate data may include an expected time-to-arrive, an assistance response, and details about the store associate assigned to the customer for providing assistance. In one implementation, the assistance response may include answer to the customer query in the text message and may be identified by analyzing the text message in the one or more assistance requests. Further, the details about the store associate may include picture and name of the store associate. In one implementation, the system 102 may analyze the one or more assistance requests to obtain the assistance details which include the customer data and the store associate data.

At block 206, the customer data and the store associate data are transmitted to the store associate mobile device 106 and the customer mobile device 104 respectively. In one implementation, the system 102 may transmit the customer data and the store associate data transmit to the store associate mobile device 106 and the customer mobile device 104. With the help of the customer data on the store mobile device 106, the store associate may easily get to know which customer is to be assisted and may easily locate the customer using the customer location and the customer picture. Further, the store associate data on the customer mobile device 104 may inform the customer about the time he/she has to wait for getting any kind of the assistance from the store associate and may provide information about the store associate assigned to the customer for providing assistance.

The systems and methods of the present subject matter thus improves the experience of the customers in the retail stores and at the same time allows the store associates to handle the one or more assistance requests from the customer efficiently. With the help of the present subject matter, the store associate assigned to the customer is specialized in category of products in which assistance is needed by the customer. The periodically updating of the customer location to the current customer location allows the store associates to easily locate the customers in the retail store for providing assistance. The customer may wander in the retail store after making the one or more assistance requests. Further, with the customer picture, the store associate may easily identify the customer to be provided assistance. The customer may have idea about for how long he/she has to wait for the assistance and which store associate is going to provide them assistance. In case the query is not complex, the customer may get the answer to the query in the assistance response on the customer mobile device 104. This may save time of the store associates and the same time may be employed in assisting the customers with complex query. Furthermore, the store associates are in possession of the order in which the store associates are supposed to assist the customers. This may help in avoiding situations, where the store associates are not sure about which customer to assist first. Therefore, the customer assistance system 102 is efficient and reliable which improves handling of the one or more assistance requests handling for providing assistance in the retails store.

Although embodiments for systems and methods for assisting customers in retail stores have been described in language specific to structural features and/or methods, it is to be understood that the invention is not necessarily limited to the specific features or methods described. Rather, the specific features and methods are disclosed as exemplary implementations for assisting customers in retail stores.

I/We claim:

1. A method for assisting customers in retail stores, the method comprising:
obtaining one or more assistance requests from a customer mobile device, wherein the one or more assistance requests include customer location and assistance information;
analyzing the one or more assistance requests to obtain assistance details, wherein the assistance details include customer data and store associate data; and
transmitting the customer data to store associate mobile devices for assisting the customer.

2. The method as claimed in claim 1 further comprising transmitting the store associate data to the customer mobile device.

3. The method as claimed in claim 1 further comprising updating the customer location to a current customer location, and wherein the current customer location is transmitted to the store associate mobile devices.

4. The method as claimed in claim 1, wherein the assistance information includes at least one of a customer image, a text message, a video, and an audio.

5. The method as claimed in claim 1, wherein the customer data comprises the customer current location and at least one of a customer picture, a text message, a video, and an audio, and an order of assisting the customer.

6. The method as claimed in claim 1, wherein the store associate data comprises at least one of an expected time-to-arrive of a store associate, and details of the store associate assigned to assist the customer.

7. The method as claimed in claim 1 further comprising transmitting an assistance response to the customer mobile device on identifying that personal assistance is not needed for the assistance needed in the text message.

8. A customer assistance system for assisting customers in retail stores, the customer assistance system comprising:
a processor;
a receiving module coupled to the processor, the receiving module configured to,
obtain one or more assistance requests from a customer mobile device, wherein the one or more assistance requests include customer location and assistance information;
a request handling module coupled to the processor, the request handling module configured to,
analyze the one or more assistance requests to obtain assistance details, wherein the assistance details include customer data and store associate data; and
a transmitting module coupled to the processor, the transmitting module configured to,
transmit the customer data to store associate mobile devices for assisting the customers.

9. The customer assistance system as claimed in claim 8, wherein the transmitting module is configured to transmit the store associate data to the customer mobile device.

10. The customer assistance system as claimed in claim 8, wherein the request handling module is configured to assign a store associate to the customer seeking assistance based on expertise and availability of the store associate.

11. The customer assistance system as claimed in claim 8, wherein the request handling module is configured to determine an order of serving the customers according to on one or more modes, and wherein the one or more modes include first come first serve, volume of purchase, whether a customer is a privileged customer or not, potential to purchase, and reward points given to the customers.

12. The customer assistance system as claimed in claim 8, wherein the request handling module is configured to determine an expected time-to-arrive based on availability of the store associates.

13. The customer assistance system as claimed in claim 8, wherein the request handling module is configured to transmit an assistance response to the customer mobile device on identifying that personal assistance is not needed for the assistance needed through a text message in the one or more assistance requests.

14. A customer mobile device for seeking assistance in a retail store, the customer mobile device comprising:
a processor;
a customer module coupled to the processor, the customer module configured to broadcast one or more assistance requests, wherein the one or more assistance requests include customer location and assistance information.

15. A store associate mobile device for providing assistance, the store associate mobile device comprising:
a processor;
a store associate module coupled to the processor, the store associate module configured to allow a store associate to opt for providing assistance to the customer based on the one or more assistance requests; and
a broadcast module coupled to the processor, the broadcast module configured to broadcast an acceptance message in a network.
